(19) United States
(12) Patent Application Publication
(10) Pub. No.: US 2018/0127599 A1
(43) Pub. Date: May 10, 2018

(54) METHOD OF PASSIVE REDUCTION OF RADAR CROSS-SECTION USING RADAR ABSORBING MATERIALS ON COMPOSITE STRUCTURES

(71) Applicant: Robert Lee Wentz, Savannah, GA (US)

(72) Inventor: Robert Lee Wentz, Savannah, GA (US)

(21) Appl. No.: 14/938,099

(22) Filed: Nov. 11, 2015

Related U.S. Application Data
(60) Provisional application No. 62/078,557, filed on Nov. 12, 2014.

(51) Int. Cl. C09D 5/32; H01Q 17/00; C09D 175/04; B05D 7/00

(52) U.S. Cl. CPC C09D 5/32; H01Q 17/00; C08K 2003/0812; B05D 7/56; C09D 175/04

(57) ABSTRACT

This invention relates to a system and method of enabling the passive reduction of radar cross-section of an object using radar absorbing materials on composite structures, such as an aircraft or unmanned aerial vehicle. The system includes a coating that is applied to a composite structure. The method includes a method of applying a coating to a composite structure.

### CROSS-REFERENCE TO RELATED APPLICATIONS

This application claims the benefit of the priority to provisional application No. 62/078,557 filed with the United States Patent and Trademark Office on Nov. 12, 2014 entitled “Method of Passive Reduction of Radar Cross-Section Using Radar Absorbing Materials on Composite Structures”, the disclosure of which is incorporated herein by reference as if fully set forth herein.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM

Not applicable.

### STATEMENT REGARDING PRIOR DISCLOSURES BY THE INVENTOR OR JOINT INVENTOR

The inventor did not disclosed the invention herein prior to the 12 month period preceding the filing of his provisional application.

### BACKGROUND OF THE INVENTION

### Field of the Invention

The present invention relates to systems and methods of blocking or reducing the radar cross section of an object that would be detected by radar, such as an airplane, missile, unmanned aerial vehicle, vessel, structure, vehicle, or other device. This method and apparatus allows an object to evade radar detection. This method and apparatus can be used during manufacture of an object or to retrofit an object that has completed the manufacturing process.

### Description of Related Art

On the B-2 stealth bomber currently has the ability to avoid missiles and interceptors. The total cost of manufacturing one B-2 bomber was estimated in 1997 to be 2.3 billion US Dollars (“USD”). Maintenance costs of the B-2 have been estimated at 3.4 million USD per month. The high cost of production and maintenance associated with the B-2 prohibits wide-scale production of these long-range bombers. And, the costs of the B-2 stealth technology prevents its incorporation into the production of other airplanes, drones, and vessels. There exists a need for an economical method or apparatus that will allow aircraft and other vessels to escape radar detection to avoid missiles and interceptors.

Aircraft, drones, and other vehicles incorporate external structures composed of advanced composites that are undetectable by enemy radar. These undetectable structures typically cover significant substructures composed of metal. Enemy radar is able to detect the aircraft via detection of its metal substructure.

Survivability of a military airplane can be significantly increased by either reducing to eliminating the radio frequency signature, acoustics, or reducing the radar cross section (“RCS”). The apparent size of a target, at a given radar wavelength (or frequency) is referred to as the “radio cross section” (“RCS”). It is typically the RCS that dictates the strength of the reflected electromagnetic pulse from a target at a specified distance from the radar transmitter. And, it is the RCS that determines whether a vehicle is detected. Any method that reduces the RCS of a vehicle or vessel will necessarily reduce the ability of enemy radar to detect the presence and location of said vehicle or vessel. Currently methods that reduce RCS include altering the surface shape of the vehicle, active electronics onboard the vehicle, or avoidance techniques and procedures.

Radar-absorbent materials are a class of materials used in stealth technology to disguise a vehicle or structure from radar detection. Passive stealth applications and methods for reducing the radar cross section of an object with conductive portions that is expected to be scanned by specific radar types has typically been reserved for more complex stealth aircraft, such as the B-2, F-22, F-35, F-117, and a few select UAS platforms. Stealth aircraft leverage a combination of electronic and material layering technology for both active and passive stealth capability. The invention herein provides a low-cost system and method of effectively reducing the RCS of an object, which will permit the armed forces to increase the number of vehicles protected from air, land, or maritime radar systems. And, this technology will allow US missiles to be protected from exposure to missile defense systems.

### BRIEF DESCRIPTION OF THE SEVERAL VIEWS OF THE DRAWINGS

FIG. 1 is flow chart depicting the method of installing radar absorbing materials (referred to as “coating”).

FIG. 2 is a cross-sectional view of a representative application of radar absorbing materials.

FIG. 3 is an expanded view of a representative application of radar absorbing materials.

FIG. 4 illustrates the passive reduction in radar cross section using an unmanned aerial system (“UAS”)

FIG. 5 is a diagram depicting the reduction of radar cross section utilizing radar absorbing materials on a manned experimental test aircraft similar to a Class IV UAS.

### DETAILED DESCRIPTION OF THE INVENTION

While this invention is susceptible of embodiment in many different forms, there are shown in the drawings and will herein be described in detail, several embodiments with the understanding that the present disclosure should be considered as an exemplification of the principles of the invention and is not intended to limit the invention to the embodiments so illustrated. Further, to the extent that any numerical values or other specifics of materials, et., are provided herein, they are to be construed as exemplifications of the inventions herein, and the inventions are not to be considered as limited thereto.

The following description and drawings are illustrative and are not to be construed as limiting. Numerous specific details are described to provide a thorough understanding of the disclosure. However, in certain instances, well-known or conventional details are not described in order to avoid obscuring the description. References to one, or an, embodiment in the present disclosure can be, but not necessarily are, references to the same embodiment; and, such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments, but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein, or is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and in no way limits the scope and meaning of the disclosure or of any exemplified embodiment. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

The present invention is directed to a system and method of blocking or reducing the radar cross section of an object that would be detected by enemy radar without the utilization of said system and method. Specifically, a radar absorbing material (“coating”) is applied to or obstruct the conductive portions of an objected that may be scanned by radar. The coating can be applied to an object that has no stealth capability or it can be applied to an object that already has a near stealth capability for increasing its capability to prevent correct detection by radar scanning.

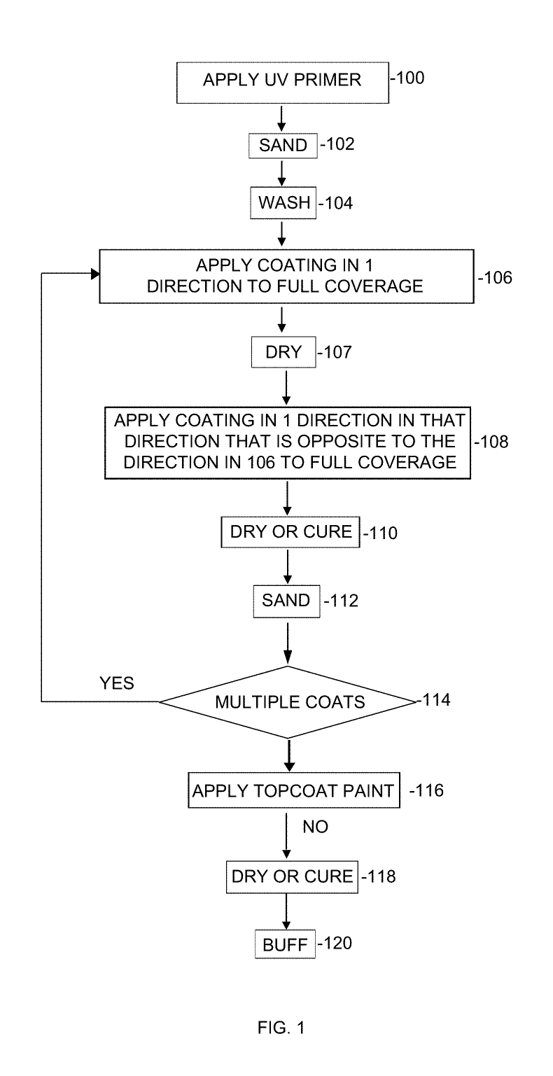

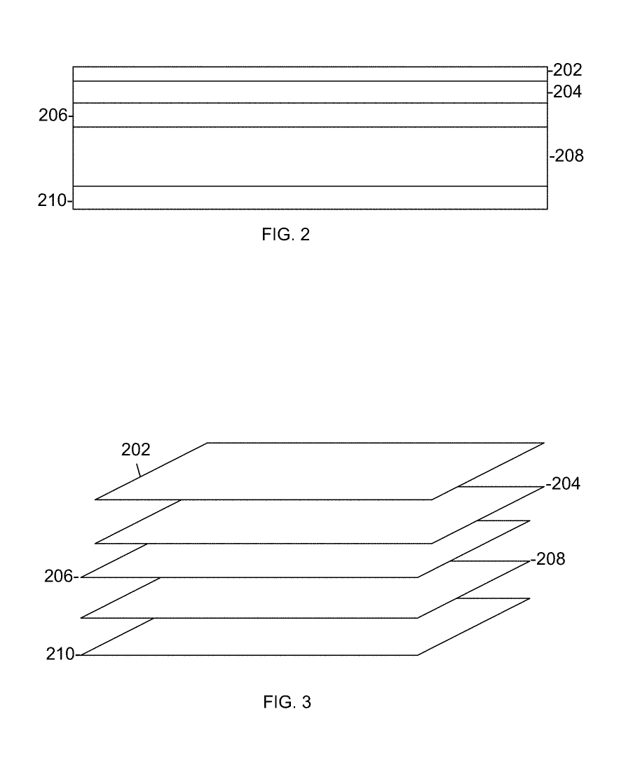

FIG. 1 is a flow chart depicting the method of applying radar absorbing coating 204 to a composite structure 208 (shown in FIGS. 2 and 3), such as the wing of an UAS. The applications at steps 100, 106, 108, and 116 may be performed using either a standard or a High Volume Low Pressure (“HVLP”) paint spray gun. The spray gun may include a fluid tip of 1.3 to 1.6 mm or equivalent, a spray velocity of 18-22 seconds #2 Zahn at 20° C., and an air pressure of 40-50 PSI for standard spray paint guns and 8 to 10 PSA at the cap for HVLP guns.

The first step at 100 in the method is to apply UV primer to the exterior surface of the composite structure 208 (shown in FIGS. 2 and 3). The UV primer may be a conventional, white, ultraviolet primer having ceramic microspheres, such as product W-410 manufactured by 3M, or any other suitable aerospace primer. UV Primer 206 protects resins in the fiberglass composite structure 208 from breakdown and provides an attachment site for radar-absorbing coating 204. UV Primer 206 (shown in FIGS. 2 and 3) may be used to create an opaque surface for application of radar-reducing coating 204 (shown in FIGS. 2 and 3). Next, the exterior surface is sanded at 102 and washed at 104. A single layer of coating 204 is applied to cover the full exterior surface of the composite structure 208 at step 106 and allowed to dry before sanding with a Scotch-Brite® pad or other scouring pad.

At step 106, radar-absorbing coating 204 is applied to a thickness of approximately 2-3 microns. Coating 204 comprises a mixture of metallic particles suspended in, and distributed evenly throughout, an acrylic urethane paint. Aluminum paste is an obbligato paste containing aluminum flakes and petroleum products. Randolph Aircraft Finishes 701 is one type of aluminum paste that may be used. Nickel paste is dispersion of nickel flakes in an inorganic silicate aqueous solution. PELCO® High Performance Nickel Pate 16059 is one type of nickel paste that may be used in certain applications. PELCO® includes 20 micron-sized flakes of nickel. Copper paste is flake copper powder pasted with low aromatic hydrocarbons. Stapa 308 copper paste is one type of copper paste that may be utilized in some applications. Randolph Aircraft Finishes 701 may be utilized as a source of acrylic urethane paint. In one embodiment, aluminum or nickel paste is blended with the acrylic urethane paint in a ratio of one part metallic paste to four parts acrylic urethane paint. The metallic particles must be suspended in the acrylic urethane paint during application. Aluminum, nickel, and copper may be added to the urethane paint in multiple concentrations singularly and in combination depending on the needs of the application. Additionally, the coating may be applied to metal external structures after a suitable primer or substrate filler has been attached to said metal structures.

Coating 204 applied at step 106 is applied so that the UV primer is still visible to the naked eye, or about a thickness of 2 microns. The application of coating 204 at step 106 is applied in a uniform direction and allowed to dry at step 107. Coating 204 should not be allowed to cure. Coating 204 application at step 108 is most effective when the composite structure 208 is dry to the touch but not fully cured. At step 108, coating 204 is applied in a single layer of approximately 2-3 microns in depth. The total thickness of coating 204 applied is approximately 4 microns. Coating 204 is applied at step 108 in the direction that is 90° from the direction of the application in step 106. For example, coating 204 may be applied to the exterior surface of composite structure 208 in the “X” direction from West to East at step 106 and applied in the “Y” direction from North to South at step 108. Coating 204 (shown in FIGS. 2 and 3) is allowed to dry or cure at step 110 before being sanded at step 112. If multiple coats of coating 204 are desired, steps 106, 107, 108, 110, and 112 may be repeated.

At step 116, acrylic urethane topcoat 202 (shown in FIGS. 2 and 3) may be applied. Topcoat 202 may be any aerospace topcoat known in the art. Topcoat 202 may be any aerospace-complaint topcoat. Topcoat may be allowed to dry or to cure at step 118. The exterior surface is then given a final buffing at step 118. Non-metallic decals and detailing may now be applied to the object.

Drying at steps 107, 110, and 118 should only take a couple of hours depending on temperature and humidity. Curing of the object at steps 110 and 118 may take three to thirty days depending on temperature and humidity.

FIG. 2 is a cross-sectional view of radar-absorbing coating 204 applied to composite structure 208, such as an airplane wing. Composite structure 208 has UV primer layer 206 applied directly to its exterior surface. Radar-absorbing coating 204 is applied as set forth in FIG. 1 on top of UV primer layer 206. Topcoat 202 is layered directly on top of coating 204. Radar-absorbing blanket 210 may be installed on the interior surface of composite structure 208 in areas that coating 204 may not be applied, such as beneath antennas or sensors that need to look outside of the aircraft. For example, radar-absorbing blanket 210 may be installed to line the floor of the aircraft where a radar dish is to be mounted. Radar-absorbing blanket 210 may be any of the commercially-available products that reduce or absorb radar.

An expanded view of a representative application of radar absorbing coating 204 is shown in FIG. 3. FIG. 3 illustrates the laying of topcoat 202 upon coating 204, which is applied onto UV Primer 206. UV Primer 206 is layered upon the composite structure 208 of an object, such as an UAV or UAS. Optional, radar absorbing blanket 210 is shown applied to the interior or underside of composite structure 208.

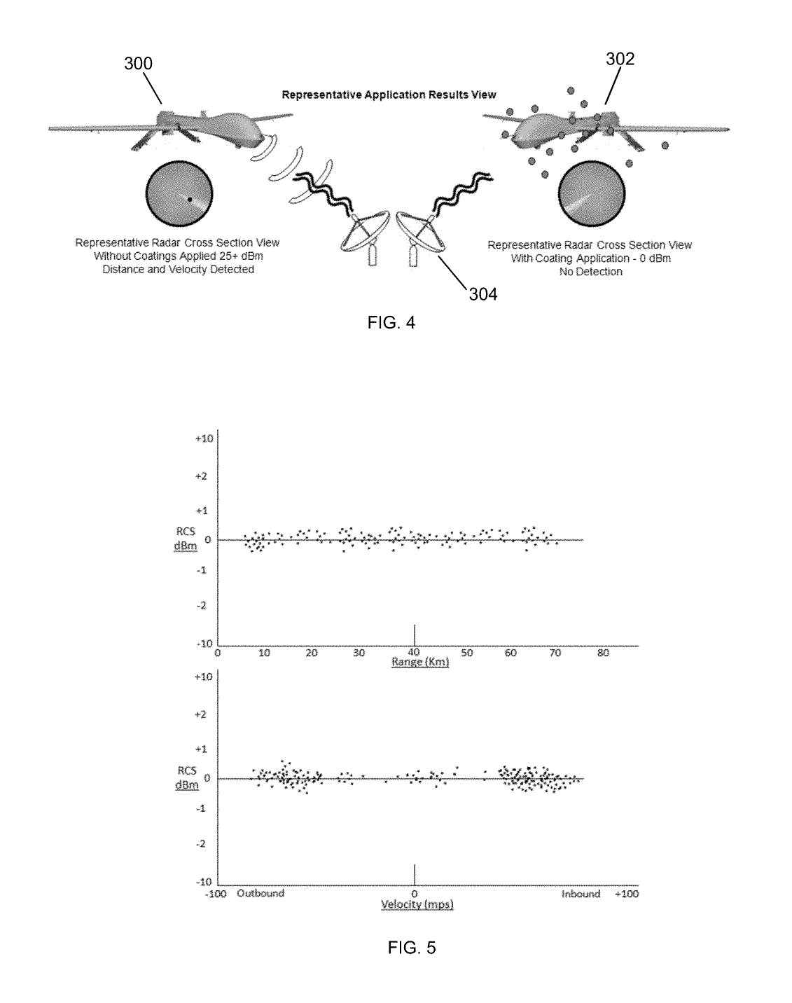

Testing of radar-absorbing coating 204 was conducted utilizing a composite structure UAV without coating 300 and utilizing a composite UAV with coating 302. FIG. 4 illustrates this testing. Radar 304 was able to detect the UAV without coating 300, but was unable to detect the UAV with radar absorbing coating 302. Both a composite structure Velocity RG aircraft without any radar absorbing coating 204 and with radar absorbing coating 204 were tested to ascertain whether coating 204 reduced the RCS of the aircraft. The Velocity RG aircraft employed had a wing span of thirty feet and was twelve in length from nose to tail. Numerous sensor registration flight profiles with horizontal velocities ranging from 70 to 95 meters per second at various altitudes were flown. The uncoated aircraft 300 produced RCS values ranging between 20 and 40 dBm during flight profiles utilizing High Intensity Pulse Doppler Radar Antenna scanning (dBm is an abbreviation for decibel-milliwatt which reflects decibels of the measured power reference to one milliwatt). The Velocity RG aircraft without coating 204 was detected at all horizontal velocities flown and all altitudes tested. FIG. 5 is a diagram depicting the test results when a composite structure Velocity RG aircraft with radar absorbing coating 204. Note, FIG. 5 reflects that the aircraft receiving radar absorbing coating 204 was essentially undetectable with an approximate dBm level of 0 detected, which would be considered noise.

I hereby claim:

1. A mixture that reduces the radar cross-section of an object when applied to said object as a coating comprising:
at least one part urethane; and
at least one part metal, wherein said metal is distributed throughout said urethane.

2. The mixture of claim 1 wherein said metal is aluminum, aluminum paste, copper, copper paste, nickel, or nickel paste.

3. The mixture of claim 1 wherein said metal includes two or more of the following metals:
aluminum, aluminum paste, copper, copper paste, nickel, or nickel paste.

4. The mixture of claim 1 wherein said urethane comprises 3 parts and said metal comprises 1 part.

5. The mixture of claim 1 further comprising applying said mixture to the fiberglass composite surfaces of an aerial vehicle, propeller, fan blade, parascope, missile, interceptor, water vessel, land vessel, or other object.

6. A method of reducing the radar cross-section of an object comprising:
applying a primer or attachment structure to said object,
applying a first coating of radar absorbing material in a first direction, wherein said radar absorbing material includes urethane mixed with a metal,
applying a second coating of radar absorbing material in a second direction, wherein said radar absorbing material includes urethane mixed with a metal, and
applying a topcoat onto said second coating of radar absorbing material.

7. The method of claim 6 wherein said first coating of radar absorbing material and said second coating of radar absorbing material is a metal.

8. The method of claim 7 wherein said metal is aluminum, aluminum paste, copper, copper paste, nickel, or nickel paste.

9. The method of claim 6 wherein said metal includes two or more of the following metals: aluminum, aluminum paste, copper, copper paste, nickel, or nickel paste.

10. The method of claim 6 wherein said first coating or radar absorbing material and said second coating of radar absorbing material comprises 3 parts urethane and 1 part metal.

11. The method of claim 6 further comprising applying said method to the fiberglass composite surfaces of an aerial vehicle, propeller, fan blade, parascope, missile, interceptor, water vessel, land vessel, or other object.
